(19) United States
(12) Patent Application Publication
(10) Pub. No.: US 2012/0012016 A1
(43) Pub. Date: Jan. 19, 2012

(54) Method and Apparatus for Retrofitting a Printing Press to Perforate a Newspaper

(75) Inventor: David N. Moeller, Seguin, TX (US)

(73) Assignee: TECH-ENERGY CO., Cibolo, TX (US)

(21) Appl. No.: 12/838,246

(22) Filed: Jul. 16, 2010

(51) Int. Cl. B41F 19/02

(52) U.S. Cl. 101/26

(57) ABSTRACT

An apparatus and method is shown to retrofit a printing press to provide for perforations in a paper at the time of printing, which perforations aid the end user in tearing out coupons or redeemable items from the paper. An existing pipe roller is removed and replaced with a perforator assembly and a perforator roller. The assembly has perforator wheels that are adjustable left and right between limits, and can be lowered when perforations are desired. A threaded drive shaft moves the perforator wheels left or right. Cylinders lower the perforator wheels during perforating. Adjustments may be made electronically, as where to set the perforator wheels.

### BACKGROUND OF THE INVENTION

1. Technical Field

This is invention relates to newspaper printing presses and, more particularly, to a method and apparatus to perforate a newspaper so that an item such as coupons can be easily removed.

2. Description of the Related Art

Printing has come a long way since being developed by the Chinese where the material to be printed was carved into wood, rolled with ink and transferred by pressure to parchment. The development of the printing press by Johannes Gutenberg in 1440 was extremely crude and used a screw-type line press to print his famous Gutenberg Bible. Even the development of linotype, type setting and motor setting left a lot to be desired in the printing industry. As early as the late 1960s, newspapers began to use digital production processes and computers. By the 1970s, offset presses were common in the newspaper business.

In the current era, offset lithography is the common way newspapers are currently printed. The image or text to be reproduced is first imaged on to a plane through a photographic negative of the content of an image. The image is placed on the paper by the use of rotating drums that contain the text and/or image. If color is desired, the paper will flow through a color tower that will add the proper color.

However, as the Internet age has arrived, more people are getting their information and news by means other than newspapers. The newspaper industry has shrunk with the newspapers merging, being reduced in size and even shut down. As a result, the newspaper industry is looking for ways to survive and generate other sources of revenue. One source of revenue newspapers have found in the last few years is printing inserts and advertisements that are sent out with their newspapers. Anytime these advertisements may have coupons or redeemable items so that customers can get reduced pricing at particular stores or locations.

One possible revenue for newspapers is if they can print coupons as part of the newspaper, which coupons can be torn out and taken to a store for redeeming in the form of reduced pricing or free goods. However, for ease of removing the coupon, some type of perforation of the newspaper is necessary at the time of printing. No device is known to Applicant to provide for such perforation of the newspaper on a selected basis. The coupons may appear in any section of the paper and it is desirable for the customer to be able to remove the coupons from the paper along the perforation line. Applicant is not aware of any device that provides for perforation of the newspaper at the time of printing.

### BRIEF SUMMARY OF THE INVENTION

It is an object of the present invention to provide a method and apparatus for perforating a newspaper at the time of printing.

It is another object of the present invention to provide a method of retrofitting an existing printing press so that perforation can be performed in the newspaper at the time of printing.

It is yet another object of the present invention to provide a method of retrofitting a printing press where an existing pipe roller is removed and replaced with the current perforating assembly.

It is another object of the present invention to provide a method of controlling the perforation by adjusting the perforator up or down to control when the perforations occur or right or left to determine the width between perforations or perforations and the edge of the paper.

A pipe roller nest is replaced with a current perforator assembly. The perforator assembly includes a urethane rubber-coated perforating roller and mounted immediately there above a support shaft with a threaded drive shaft. The threaded drive shaft will move a perforating head left and right with a pneumatic cylinder moving the perforating roller up and down. Drive rods are held in place by end brackets, all of which are supported on a support shaft. Limit switches make sure the perforators do not move too far right or left.

There are separate drive shafts on each side of the perforator assembly with different motors being on each side to control either the left or the right drive shaft. By use of a split collar, the perforator roller and the perforator assembly can easily replace an existing pipe roller.

By use of the proper electronic controls, the perforator assembly can be set to provide a perforated line along any particular fixed point in the newspaper as it feeds along to the rollers. A perforator head would be raised when no perforation is desired. Once the perforator has been positioned, left or right, it may then be lowered to provide the perforation desired.

### BRIEF DESCRIPTION OF THE DRAWINGS

FIG. 1 is a side view of a printing press showing a color tower and folder as exists in the prior art.

FIG. 2 is a pipe roller as used by a printing press in the prior art.

FIG. 3 is an elevated view showing how the prior art pipe roller is replaced with a perforator assembly.

FIG. 4 is a perspective view showing the perforator assembly as installed.

FIG. 5 is an enlarged perspective view of an individual perforator.

FIG. 6 is a control panel for perforators 1 through 4.

FIG. 7 is a control diagram for a single perforator in the UP position.

FIG. 8 is a control diagram for a single perforator in the DOWN position.

### DESCRIPTION OF THE PREFERRED EMBODIMENT

Referring now to FIG. 1, an elevated view of a portion of a printing press 11 is shown. A roll of paper 13 is rotatably mounted on roll stand 15. From the roll stand 15, paper 17 feeds from the roll of paper 13 up through color tower 19. Color tower 19 will have a yellow color unit 21, blue color unit 23 and red color unit 25. If color is not needed, a black color unit 27 is also provided. Depending what is needed in that section of the newspaper, appropriate printing will occur on paper 17. The paper 17 also feeds through pipe roller nest 29 located at the top of the color tower 19. In the pipe roller nest 29 are located a series of pipe rollers 31.

From the pipe roller nest 29, the paper 17 feeds to a folder unit 33. The folder unit 33 consists of an upper folder 35 with upper folder board 37. If needed, the paper 17 can also feed to lower folder 39 and lower folder board 41. Lead-in rollers 43 maintain tension on the paper 17 as it feeds from the color tower 19 to the folder unit 33.

As the paper 17 feeds through upper folder 35, then lower folder 39, it goes across a cutting cylinder (not shown) and a folding cylinder 45. From the folding cylinder 45, the newspaper drops down onto conveyor belt 47.

The particular newspaper being run may call for strictly black and white and no color. Then, newspaper may be taken from paper roll 49 on the single black print unit 51. It may be that different sections are being formed at one time and each of those different sections of the paper will come together on a conveyor belt 47. There may be six or seven different webs coming in to form a section and then each section coming together to form the entire paper.

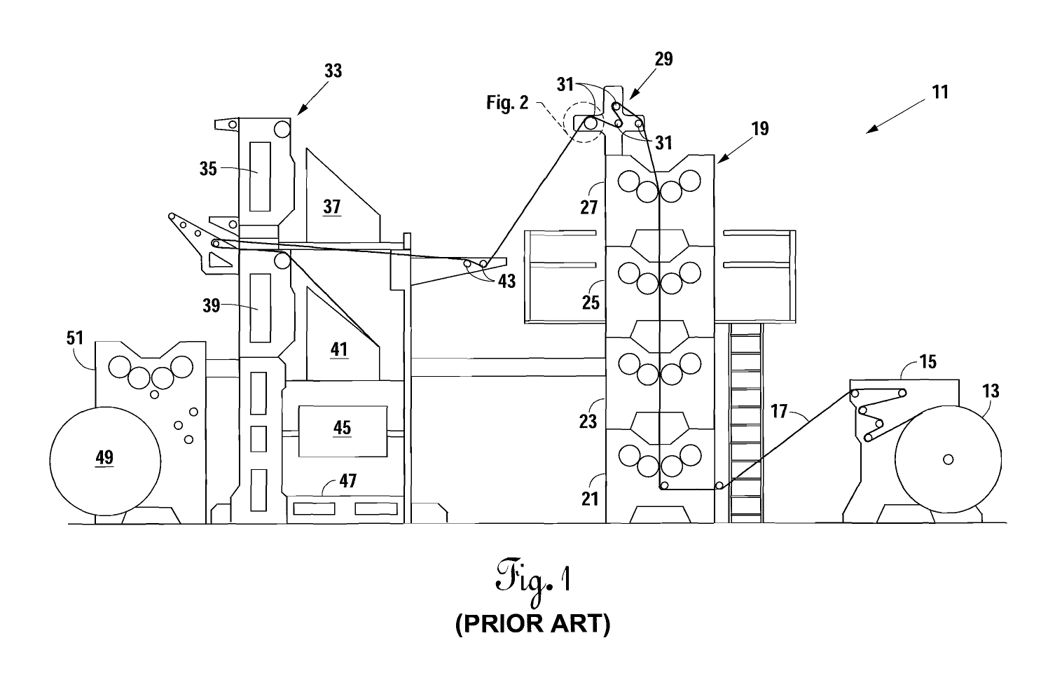

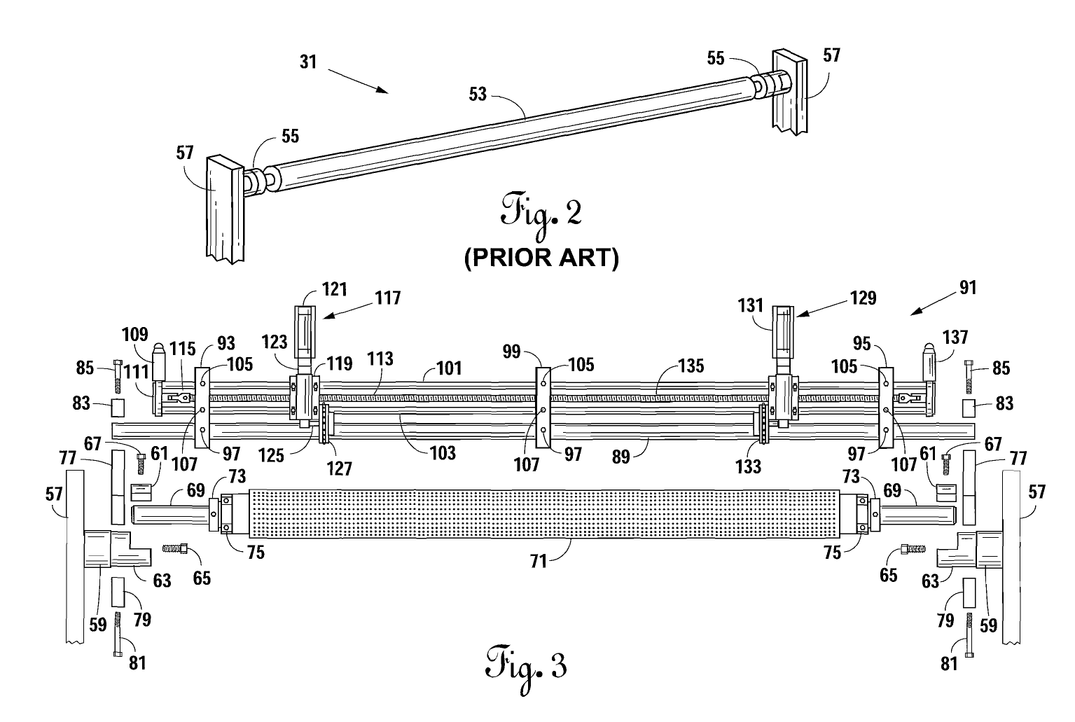

Turning now to FIG. 2, a perspective view is shown of a single pipe roller 31 as contained in the pipe roller nest 29 of FIG. 1. The pipe roller 31 has a cylindrical pipe 53 rotatably mounted by bearings 55 on either end thereof to press frame 57.

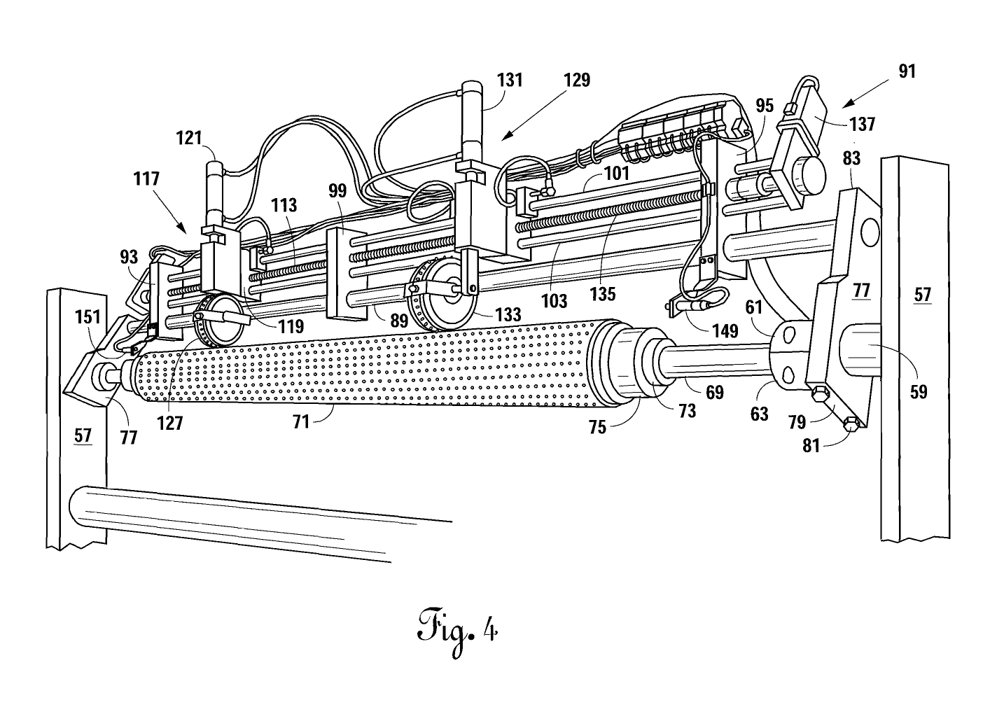

The paper 17, also referred to as a “web”, feeds over cylindrical pipe 53, which is free to rotate inside a bearing 55, all of which is mounted on press frame 57. In FIG. 3, the cylindrical pipe 53 is removed along with the bearings 55. Attached to the pipe roller-mounting bracket 59 is a lower split collar 63 held in position on the pipe roller-mounting bracket 59 by lower split collar screws 65. The upper split collar 61 is attached to the lower split collar 63 by split collar screws 67.

Held between the upper split collar 61 and lower split collar 63 is center shaft 69. Center shaft 69 extends from the left split collar to the right split collars as shown in FIG. 3. Mounted on the center shaft 69 is a perforator roller 71 that has a blend of urethane and rubber on the outside thereof. The blend should be hard enough for a perforator to cut the web or paper 17, but at the same time have enough resiliency to return to its original condition. At the same time, the perforator roller 71 should be durable enough not to wear out with the continuous running of the paper 17 there across. Applicant has found that a coating that has approximately 90 durometers of hardness is close to the ideal hardness. The specific urethane rubber blend that is being used by Applicant is made by Tech-Energy Co. and is identified as “coated perforator roller”.

The perforator roller 71 is maintained in position by stops 73 on either end thereof. Bearings 75 allow for ease of rotation of the perforator roller 71 on the center shaft 69. Center shaft 69 does not rotate.

Also mounted on the lower split collar 63 is a perforator assembly mounting bracket 77. The perforator assembly-mounting bracket 77 is held in position by lower mounting block 79 and screws 81 that threadably attach to the perforator assembly-mounting bracket 77. At the top of the perforator assembly-mounting bracket 77, upper mounting block 83 is threadably connected thereto with upper mounting block screws 85. Secured between the upper mounting block 83 and the perforator assembly-mounting bracket 77 is support shaft 89. Support shaft 89 is prevented from rotating by any convenient means such as a flat surface on one side thereof and set screws (not shown) connecting into the flat surface. A perforator assembly 91 mounts on the support shaft 89.

The perforator assembly 91 has a left end bracket 93 and a right end bracket 95 securely fastened to support shaft 89 and held in position by setscrews 97. Center bracket 99 is also attached to support shaft 89 and held in position by setscrews 97. The setscrews 97 screw into a flat portion or a flat mill out of support shaft 89.

Also held in position by left end bracket 93, right end bracket 95 and center bracket 99 is top guide rod 101 and bottom guide rod 103. Top guide rod 101 does not rotate and is held in position by top guide rod set screws 105. Likewise, the bottom guide rod 103 is held in position by bottom guide rod set screws 107.

On the left end of the perforator assembly 91 is a left drive motor 109 mounted on the left end of the top guide rod 101 and the bottom guide rod 103 by left drive motor bracket 111. The left drive motor 109 connects to left threaded drive shaft 113 by left universal joint 115. By appropriate signal to the left drive motor 109, the left perforator head 117 may be moved either left or right. The thread of the left threaded drive shaft 113 threadably engage with the left perforator head-mounting bracket 119. Turning of the left threaded drive shaft 113 by left drive motor 109 will cause the left perforator head 117 to move either left or right depending on the direction the left drive motor 109 was turning.

Connected to the top of the left perforator head mounting bracket 119 is left pneumatic cylinder 121. Left pneumatic cylinder 121 either extends or retracts left pneumatic cylinder shaft 123. On the lower end of the left pneumatic cylinder shaft 123 is a left perforator shaft 125 extending at a right angle thereto. The left perforator 127 rotates on the left perforator shaft 125. By applying pressure to the left pneumatic cylinder 121, the left pneumatic cylinder shaft 123 is extended causing the left perforator shaft 125 to lower the left perforator 127.

The same explanation explaining the operation of the left perforator head 117 applies to the right perforator head 129. Therefore, the explanation will not be repeated herein. It is only necessary to identify by number the right pneumatic cylinder 131 and the right perforator 133, which are carried on the right threaded drive shaft 135. The right threaded drive shaft 135 is operated by right drive motor 137.

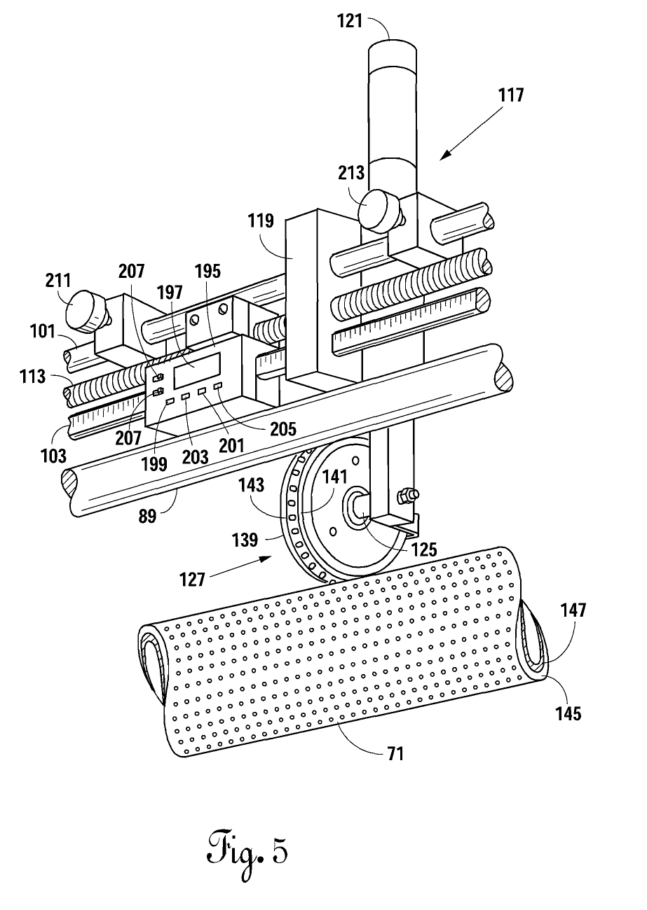

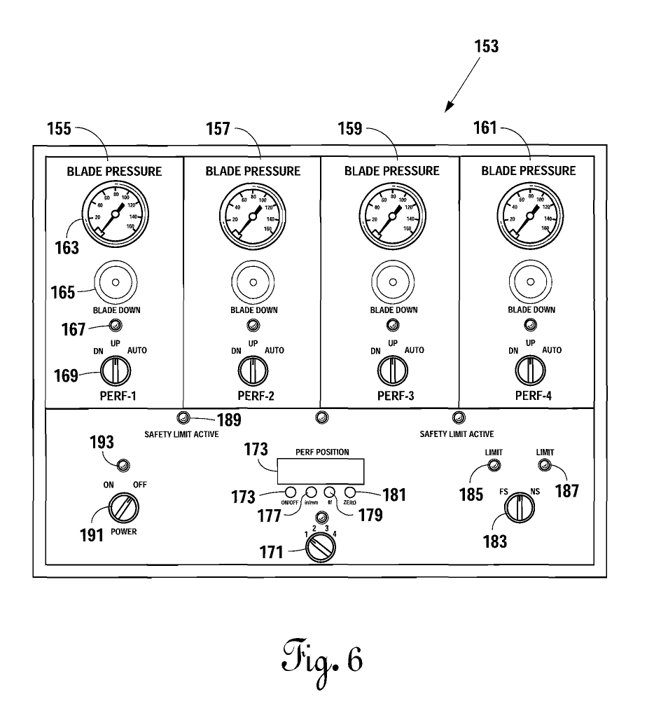

Referring to FIGS. 4 and 5 in combination, these figures show the perforated assembly 91 fully connected into the printing press 11 with pneumatic and electrical connections. Referring first to FIG. 5, an enlarged partial rear perspective view of the left perforator head 117 is shown. The left perforator 127 has a left trolley wheel 139 and a right trolley wheel 141 with a perforator wheel 143 being located there between. The perforator wheel 143 extends about 1/32,000 of an inch radially from left trolley wheel 139 and right trolley wheel 141. The 1/32,000 of an inch is enough so that when pressed against the paper 17 on perforator roller 71, perforations will be cut in the newspaper 17. Also, as can be seen in FIG. 5, the perforator roller 71 has the urethane rubber blend coating 145 applied to metal cylinder 147. The urethane rubber blend coating 145 is resilient to return to its original position after having the perforator wheel 143 pressed there against, but only for 1/32,000 of an inch.

Referring back to FIG. 4, a front perspective view is shown of the perforator assembly 91. Like numbers have been applied to like parts as previously described in conjunction with FIGS. 3 and 5. An additional feature, not described in conjunction with FIG. 3 is shown in FIG. 4 as a laser sensor consisting of a laser sending unit 149 and a laser receiving unit 151. When the left perforator 127 or right perforator 133 is down in perforating preparation, if the laser beam from the laser sending unit 149 is interrupted and not received by the laser receiving 151, the perforator that is being used is raised by removing the pressurized air from either left pneumatic cylinder 121 or right pneumatic cylinder 131.

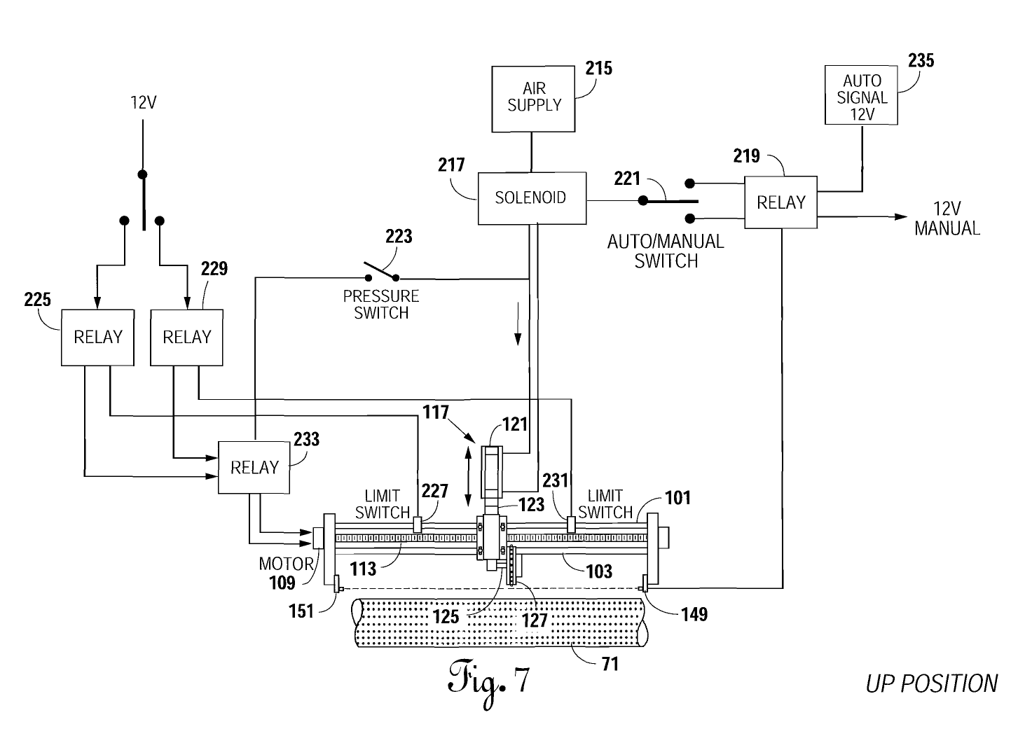

Referring to FIG. 6, a control box 153 is located at the control station to communicate with the operator of the printing press 11. The control box 153 has a left perforator control panel 155 for the left perforator 127 and the right perforator control panel 157 for the right perforator 133. Two additional control panels 159 and 161 are provided to control additional perforators (not shown nor described). For the sake of illustration, Applicant will describe in detail only the left perforator control panel 155.

The pressure gauge 163 indicates the pressure being applied to the left pneumatic cylinder 121 (see FIG. 3) which is typically around 15 psi. If too much pressure is applied, it can cause problems with the feed of the paper 17. However, not enough pressure and the perforator wheel 143 will not cut the paper. The pressure delivered to the left pneumatic cylinder 121 as measured by pressure gauge 163 can be adjusted by pressure control knob 165. If indicator light 167 is lit that means the perforator wheel 143 is down. Selector switch 169 allows the operator to select concerning the left perforator 127 as to whether it is up, down or is operating in an automatic mode.

Perforator selector switch 171 allows the operator to select one of the four perforators being monitored. For the sake of explanation, the numeral 1 refers to “PERF-1” which is controlling the left perforator control panel 155 and left perforator 127. The position of the left perforator 127 is indicated in the digital read-out 173. Below the digital read-out 173 is a series of push buttons. Assuming the perforator selector switch 171 is on the numeral 1, which indicates the digital read-out 173 is monitoring “PERF-1”, which for this explanation is the left perforator 127 as indicated in the left perforator control panel 155. The ON/OFF switch 175 will turn ON or OFF the digital read-out 173. Assuming the ON/OFF switch 175 is ON, the position of the left perforator 127 can be measured in either inches or meters by pushing the INCH/METER switch 177. If a particular position has been programmed in memory by the left perforator 127, by pushing the memory select switch 179, the position as contained in memory can be called up. If at any time during the operation it is necessary to move the left perforator 127, but its position prior to movement needs to be recorded, then the zero switch 181 is pressed to maintain the zero set point.

Assuming the perforator selector switch 171 is still set for the numeral 1 which indicates the left perforator 127 is being controlled, motor switch 183 may be turned left or right to adjust the left perforator 127 either left or right assuming the left perforator 127 is raised at that time. Since the control box 153 is located at the operator station, the operator station does not use “left” or “right”. Instead, the operator thinks in terms of “far side” or “near side”. Therefore, the notations “FS” and “NS” are used for the motor switch 183. Depending upon the arrangement of the printer press 11, “FS” could be either left or right.

If the motor switch 183 is turned and the limit switch is reached for the left perforator head 117, far side indicator light 185 or near side indicator light 187 will be lit.

If someone interrupts the laser beam from the laser sensing unit 149 to the laser receiving unit 151 as described in connection with FIG. 4, safety limit active indicator 189 will light up indicating the laser beam has been broken. When that occurs, the pressure being applied to the left pneumatic cylinder will be removed and the left perforator 127 will be raised.

Power for the entire system may be turned ON or OFF by power knob 191. If power is ON, power indicator light 193 will light up.

Referring back to FIG. 5, the controls at the operator station can also be made on the line by someone adjusting the equipment. As is explained in conjunction with left perforator head 117, a digital control box 195 has the same information concerning left perforator as is contained in the control box 153 at the control station. Local digital readout 197 provides the same information as digital readout 173 in the control box 153.

Likewise, local ON/OFF switch 199 turns the local digital readout 197 ON or OFF. Local inches/meter switch gives the position of the perforator head in inches or meters. Also, local memory select switch 203 allows a particular position to be stored in memory. Lastly, local zero switch 205 allows a position of the perforator head to be zeroed out at the perforator head. If preset conditions are to be loaded into the digital control box 195, they can be set by preset switches 207 and 209. A left limit can be set for left perforator head 117 by left set knob 211. Likewise, the right limit switch can be set by right set knob 213.

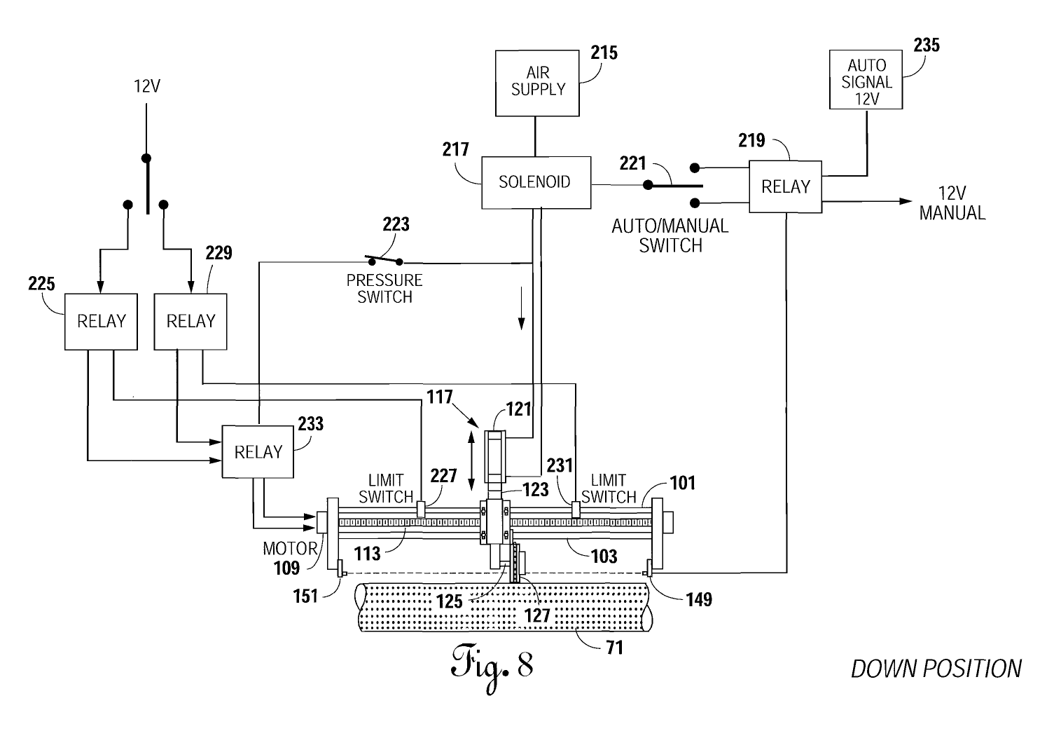

Referring to FIGS. 7 and 8 in combination, a pictorial block diagram is shown for the adjustment of a perforator head. For the purposes of the present illustration, it is assumed that the perforator head shown in FIGS. 7 and 8 is left the perforator head 117. Air supply 215 is controlled by solenoid 217, which allows pressurized air to flow to or from left pneumatic cylinder 121. If the air supply 215 is delivered to the left pneumatic cylinder 121, the left pneumatic cylinder shaft 123 will be extended, which will lower the left perforator shaft 125 and the left perforator 127. The laser sending unit 149 and the laser receiving unit 151 are actually located in front of the left perforator 127. If the laser beam is interrupted while the left perforator 128 is down, safety relay 219 will be activated to operate the auto/manual switch 221 to remove the air delivered by the air supply 215 and hence raise the left perforator 127.

If the pressure switch 223 is closed, which means the left perforator 227 is down, then the left perforator head 117 cannot be moved either left or right. However, assuming the left perforator 227 is raised to the UP position as shown in FIG. 7, by operation of the left relay 225, the left perforator head 117 can be moved to the left until it hits the left limit switch 227. Likewise, by operating the right relay 229, the left perforator head 217 can be moved until it reaches the right limit switch 231. Note the left relay 225 and the right relay 229 feeds through motor relay 233 to turn the left drive motor 109 either right or left, depending upon which has been selected.

While other voltages could be used, a 12 Volt supply 235 is recommended.

What I claim is:

1. A method of retrofitting a printing press to perforate a newspaper at the time of printing, comprising the following steps:
removing a pipe roller from the printing press;
inserting a perforator assembly in place of said pipe roller, said perforator assembly being:
(a) a center shaft held in position by a split collar;
(b) perforating roller rotatably mounted on said center shaft;
(c) perforating wheels for pressing against said newspaper and said perforating roller to make perforations in said newspaper;
adjusting said perforating wheels with respect to said center shaft;
setting left and right limits of said perforating wheels; and
lowering or raising said perforating wheel so that said perforating only occurs at selected times.

2. The method of retrofitting a printing press to perforate the newspaper at the time of printing as recited in claim 1 wherein said inserting step includes attaching mounting brackets at each end of said center shaft and mounting a support shaft there between, said perforating wheels being supported by said support shaft.

3. The method of retrofitting a printing press to perforate the newspaper at the time of printing as recited in claim 2 wherein said lowering or raising occurs by applying pressurized air to pneumatic cylinders to lower or raise said perforating wheels.

4. The method of retrofitting a printing press to perforate the newspaper at the time of printing as recited in claim 2 includes a further step of securing guide brackets to said support shaft, said guide brackets securing guide rods there between, said guide rods being generally parallel with perforating roller.

5. The method of retrofitting a printing press to perforate the newspaper at the time of printing as recited in claim 4 wherein said guide rods slideably mount a perforator head mounting brackets thereon, each of said perforator head mounting brackets having a perforator wheel rotatably mounted thereon, a threaded drive shaft threadably extending through each said perforator head mounting bracket to move each said perforator wheel left or right before beginning to perforate.

6. The method of retrofitting a printing press to perforate the newspaper at the time of printing as recited in claim 5 wherein the position of each said perforating wheel is set by a motor turning said threaded drive shaft to move said perforating head mounting bracket and said perforating wheel.

7. The method of retrofitting a printing press to perforate the newspaper at the time of printing as recited in claim 6 wherein multiple perforating wheels are set by repeating many of the above steps.

8. An apparatus for retrofitting a printing press to perforate a paper at the time of printing, the apparatus replacing an existing roller mounted on a press frame, said apparatus comprising:
perforator assembly brackets attached to each side of said press frame;
a center shaft extending between said perforator assembly mounting brackets;
a perforating roller rotatably carried on said center shaft;
support shaft generally parallel to said perforating roller and held adjacent thereto by said perforator assembly mounting brackets;
guide rods mounted on, and generally parallel to, said support shaft;
perforator head mounting brackets slideably mounted on said guide rods;
threaded drive shaft for moving said perforator head mounting brackets along said guide rods;
perforating wheels mounted on said perforator head mounting brackets, said perforating wheels being pressed against said paper and said perforating roller during perforation and raised when perforation is not desired.

9. The apparatus for retrofitting a printing press to perforate a paper at the time of printing as recited in claim 8 further includes pneumatic cylinders on said perforator head mounting brackets for said pressing said perforator wheels against said paper and said perforating roller or raising said perforator wheels.

10. The apparatus for retrofitting a printing press to perforate a paper at the time of printing as recited in claim 9 wherein each perforating wheel has a separate said threaded drive shaft.

11. The apparatus for retrofitting a printing press to perforate a paper at the time of printing as recited in claim 10 wherein limits are mounted on said guide rods to prevent said perforating wheels from moving outside of predetermined limits.

12. The apparatus for retrofitting a printing press to perforate a paper at the time of printing as recited in claim 10 wherein said threaded drive shafts are rotated by drive motors to move said perforating wheels to predetermined locations.

13. The apparatus for retrofitting a printing press to perforate a paper at the time of printing as recited in claim 12 having a control box to set conditions for said perforations.
